(19) United States
(12) Patent Application Publication
(10) Pub. No.: US 2010/0302977 A1
(43) Pub. Date: Dec. 2, 2010

(54) TIME-REVERSAL METHOD OF PRE-EQUALIZING A DATA SIGNAL

(75) Inventors: Dinh Thuy Phan Huy, Paris (FR); Jean-Marie Chaufray, Chatenay Malabry (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/745,034

(22) PCT Filed: Dec. 19, 2008
(86) PCT No.: PCT/FR08/52377

§ 371 Date: Jul. 12, 2010

(30) Foreign Application Priority Data
Dec. 21, 2007 (FR) 0760228

(51) Int. Cl. H04J 1/00

(52) U.S. Cl. 370/281

(57) ABSTRACT

A method of pre-equalizing a frequency-division duplex data signal transmitted by a source communicating entity having a set of source antennas to a destination communicating entity having a set of destination antennas, the method comprising a step of transmitting a pulse via a destination antenna to the source communicating entity, a step of the destination antenna transmitting to the source communicating entity a combined impulse response representing the successive passage of said pulse through a first propagation channel between the destination antenna and a reference antenna of the set of source antennas and a second propagation channel between a source antenna and the destination antenna, said step being repeated for at least some of the source antennas, the steps of transmission of a pulse and iterative transmission of a time-reversed impulse response being repeated for at least some of the destination antennas, and a step of determining pre-equalization coefficients of the data signal from a combination of a set of time-reversed combined impulse responses received by the source communicating entity.

The present invention relates to a method of pre-equalizing a data signal, for example one transmitted in a frequency-division duplex (FDD) radio communications network.

In an FDD network, two communicating entities transmit data signals in different frequency bands. The communicating entities are radio terminals, terrestrial or satellite base stations, or radio access points, for example. The invention relates to single-input, single-output (SISO) radio communications networks, in which each communicating entity has a single antenna, multiple-input, multiple-output (MIMO) networks, in which each communicating entity has a plurality of antennas, and single-input, multiple-output (SIMO) or multiple-input, single-output (MISO) networks combining communicating entities having only one antenna and communicating entities have a plurality of antennas.

A radio signal (antenna signal) transmitted by an antenna of a communicating entity suffers distortion as a function of the propagation conditions between a source point defined at the output of the source antenna and a destination point defined at the input of an antenna of the destination communicating entity. To limit such distortion, the antenna signal is pre-distorted by applying pre-equalization coefficients as a function of the characteristics of the propagation channel between the two antennas. It is therefore necessary to characterize this propagation channel.

Of existing pre-equalization methods, time-reversal methods are distinguished by their reduced complexity and their performance.

Time reversal is a technique for focusing waves, typically acoustic waves, that relies on the invariance of the time-reversed wave equation. Thus a time-reversed wave propagates like a direct wave traveling backwards in time.

A brief pulse transmitted from a source point propagates in a propagation medium. Part of this wave received by a destination point is time reversed before being sent back in the same propagation medium. The wave converges towards the source point, where it forms a brief pulse. The signal collected at the source point is of virtually identical shape to the source signal transmitted from the source point. In particular, the more complex the propagation medium, the more accurately the time-reversed wave converges. Time reversing the propagation channel to which the wave is applied makes it possible to cancel out the effect of the channel on the wave pre-distorted in this way transmitted from the source point.

Thus the time reversal technique is used in radio communications networks to cancel out the effect of the propagation channel on the antenna signal, notably by reducing channel spreading, and to simplify the processing of symbols received after passing through the channel. The antenna signal transmitted by an antenna of the source communicating entity is pre-equalized by applying coefficients obtained from the time-revered impulse response of the propagation channel through which this antenna signal must pass. Applying time reversal thus requires the source communicating entity to have knowledge of the propagation channel in the frequency band dedicated to communications issuing from that entity.

FDD transmission from a source communicating entity to a destination communicating entity and transmission in the opposite direction are effected in different frequency bands. For example, for a radio communications system this means uplink transmission in a first frequency band from a mobile radio terminal to a base station and downlink transmission in a second frequency band from a base station to a mobile radio terminal. Although a communicating entity can estimate a propagation channel on the basis of receiving a signal passing through the channel, it cannot estimate a propagation channel on the basis of a signal transmitted in a different frequency band. No reciprocity property of the transmission channel may be applied, in contrast to TDD transmission for which sharing the same frequency band makes it possible simply to estimate the channel independently of the transmission direction. It is therefore particularly beneficial for FDD transmissions to use a technique for pre-equalizing antenna signals.

A first solution is proposed in the paper entitled “From theory to practice: an overview of MIMO space-time coded wireless systems” by David Gesbert, Mansoor Shafi, Da-Shan Shiu, Peter J Smith, and Aymon Naguib, published in IEEE Journal on Selected Areas in Communication, vol. 21, no. 3, April 2003. The proposed method uses time reversal as a pre-equalization technique with coefficients evaluated on the basis of the destination communicating entity's estimate of the propagation channel. The destination communicating entity bases this estimate on its knowledge of pilots previously transmitted by the source communicating entity. The estimate of the propagation channel is then delivered to the source communicating entity.

Thus inserting pilots makes it possible to estimate the propagation channel, but this requires the use of complex techniques in the destination communicating entity. Furthermore, the complexity of the channel estimator increases with the number of pilots available and the requirement in terms of radio resources necessary to deliver the estimate increases with the accuracy of the estimate required to guarantee effective pre-equalization. A compromise must therefore be achieved between the accuracy of the estimate of the propagation channel and the consumption of radio resources used to transmit the pilots and to estimate the channel.

An alternative method is described in the paper entitled “Blind beamforming in frequency division duplex MISO systems based on time-reversal mirrors” by Tobias Dahl and Jan Egil Kirkebo, presented at the IEEE Conference 6th Workshop on Signal Processing Advances in Wireless Communications, June 2005, SPAWC.2055.1506218, pages 640-644. That so-called blind method is based on a round trip of the antenna signal between the communicating entities. The time-reversal coefficients applied at a given time are obtained from the stored data signal and the pre-equalization coefficients applied to that signal at a previous time. That method therefore makes it possible to dispense with the use of pilots and channel estimation, but at the cost of increased complexity and voluminous digital signal storage.

Neither of the solutions described above, respectively based on using pilots and on an antenna signal round trip, is entirely satisfactory. The invention therefore proposes an alternative solution offering a pre-equalization method based on time reversal with reduced complexity and without using pilots. This solution is furthermore suitable for communicating entities with a single antenna for which the data signal consists of a single antenna signal and for communicating entities with a plurality of antennas for which the data signal consists of a plurality of antenna signals.

To achieve this object, the invention provides a method of pre-equalizing a frequency-division duplex data signal transmitted by a source communicating entity having a set of source antennas to a destination communicating entity having a set of destination antennas. The method includes:
a step of transmitting a pulse via a destination antenna to the source communicating entity;
a step of iterative processing of said pulse including:
   a substep of a source antenna transmitting to the destination communicating entity the pulse received via a reference antenna of the set of source antennas;
   a substep of the destination communicating entity time reversing the combined impulse response representing the successive passage of the pulse through a first propagation channel between the destination antenna and the reference antenna and a second propagation channel between the source antenna and the destination antenna; and
   a substep of the destination antenna transmitting the time-reversed combined impulse response to the source communicating entity;
said step of iterative processing of the pulse being repeated for at least some of the source antennas;
the steps of transmission of a pulse via a destination antenna and iterative processing of said pulse being repeated for at least some of the destination antennas; and
a step of determining pre-equalization coefficients of the data signal from a combination of a set of time-reversed combined impulse responses received by the source communicating entity.

Thus this method makes it possible to dispense with channel estimation. Accordingly, firstly, no complex digital processing is necessary and, secondly, the destination communicating entity frees up the resources previously intended to deliver the propagation channel estimate or estimates. Moreover, no pilot is required to implement the method.

Thus in the destination communicating entity the complexity of the pre-equalization method of the invention is limited to time reversing an impulse response.

The method further includes, in the substep of transmitting the received pulse, selecting the reference antenna as a function of a set of pulses received by the set of source antennas. The reference antenna is selected as a function of the energy of all the pulses received by all the source antennas, for example.

For example, such selection makes it possible to give preference to the second propagation channel, in which the energy of the signal is attenuated the least.

The pre-equalization coefficients are determined from a combination of a set of time-reversed combined impulse responses received by the reference antenna of the source communicating entity.

The method thus makes it possible to adapt to different precoding and modulation methods applied to binary data to generate a data signal including a plurality of antenna signals.

The invention also provides a device for pre-equalizing a data signal for a source communicating entity having a set of source antennas, the source communicating entity being adapted to transmit the signal, using frequency-division duplexing, to a destination communicating entity having a set of destination antennas. The device includes:
means for receiving a pulse transmitted via a destination antenna;
means for transmitting the received pulse to the destination communicating entity via a source antenna;
means for receiving a time-reversed combined impulse response representing the successive passage of the transmitted pulse through a first propagation channel between the destination antenna and a reference antenna of the set of source antennas and a second propagation channel between the source antenna and the destination antenna;
means for determining coefficients for pre-equalizing the data signal on the basis of a combination of a set of received time-reversed combined impulse responses;

the transmission and reception means being used iteratively for at least some of the destination antennas and at least some of the source antennas.

The invention further provides a device for pre-equalizing a data signal for a destination communicating entity, including a set of destination antennas, the destination communicating entity being adapted to receive the data signal transmitted, using frequency-division duplexing, by a source communicating entity including a set of source antennas. The device includes:
means for transmission of a pulse to the source communicating entity via a destination antenna;
means for receiving a combined impulse response representing successive passage of said pulse through a first propagation channel between the destination antenna and a reference antenna of the set of source antennas and a second propagation channel between a source antenna and the destination antenna;
means for time reversing the combined impulse response;
means for transmitting said time-reversed combined impulse response;

the transmission, reception and time reversing means being used iteratively for at least some of the destination antennas and at least some of the source antennas.

The invention further provides a communicating entity of a radio communications system including at least one of the above data signal pre-equalizer devices.

The invention further provides a radio communications system including at least two communicating entities of the invention.

The devices, communicating entities and system have advantages similar to those described above.

Other features and advantages of the present invention become more clearly apparent on reading the following description of the methods of particular implementations of the invention for pre-equalizing a data signal and associated communicating entities, given by way of illustrative and non-limiting example only and with reference to the appended drawings, in which:

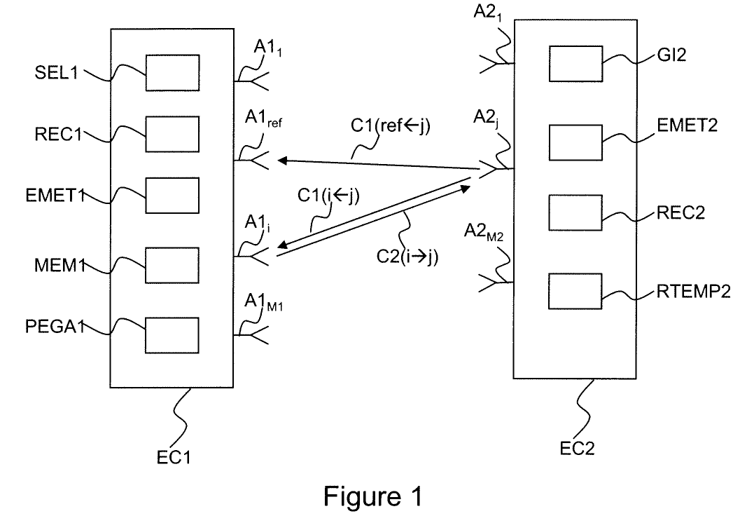

FIG. 1 is a block diagram of a source communicating entity of the invention communicating with a destination communicating entity of the invention; and

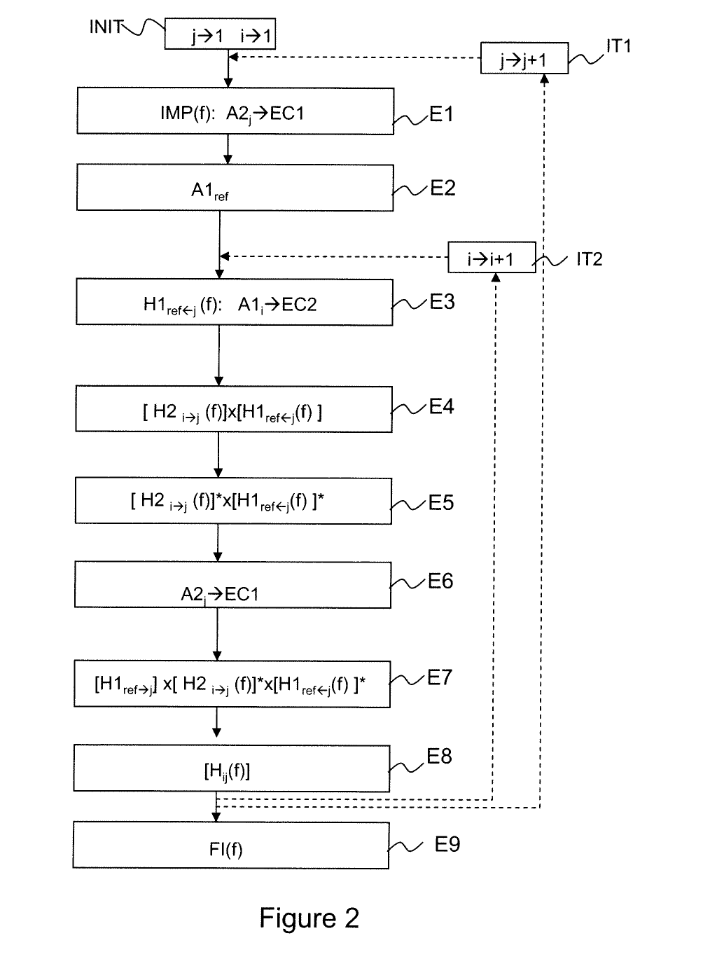

FIG. 2 represents the steps of the method of a first particular implementation of the invention of pre-equalizing a data signal.

Referring to FIG. 1, a source communicating entity EC1 is able to communicate with a destination communicating entity EC2 via a frequency division duplex (FDD) radio communications network not represented in the figure.

For example, the radio communications network is a UMTS (Universal Mobile Communications system) cellular radio communications network defined by the 3GPP (3rd Generation Partnership Project) organization and evolutions thereof including 3GPP-LTE (Long Term Evolution).

Possible communicating entities are mobile terminals, terrestrial and satellite base stations, and access points. FDD uplink transmission from a base station to a mobile radio terminal is effected in a frequency band different from the frequency band dedicated to downlink transmission from a mobile radio terminal to a base station. For clarity, the invention is described for the unidirectional transmission of a data signal from the communicating entity EC1 to the communicating entity EC2, whether that is in the uplink direction or in the downlink direction. The invention also relates to bidirectional transmission.

The source communicating entity EC1 has M1 source antennas (A1₁, . . . A1_{ref}, . . . A1ᵢ, . . . A1_{M1}), where M1 is greater than or equal to 1. The destination communicating entity has M2 destination antennas (A2₁, . . . A2ⱼ, . . . A2_{M2}) where M2 is greater than or equal to 1.

The destination communicating entity EC2 is able to transmit a pulse or a radio signal from any one or more of the antennas A2ⱼ, for j between 1 and M2 inclusive, to the source communicating entity EC1 in a first frequency band. A first propagation channel C1(A1ᵢ←A2ⱼ) is defined between the antenna A2ⱼ of the communicating entity EC2 and an antenna A1ᵢ of the source communicating entity EC1. Thus M1×M2 first propagation channels Cl(A1ᵢ←A2ⱼ), for i varying from 1 to M1 and j varying from 1 to M2, are defined between the communicating entities EC1 and EC2.

The source communicating entity EC1 is adapted to transmit a radio signal or pulse from any one or more of the antennas A1ᵢ, for i between 1 and M1 inclusive, to the destination communication entity EC2 in a second frequency band different from the first. A second propagation channel C2(A1ᵢ→A2ⱼ) is defined between the antenna A1ᵢ of the communicating entity EC1 and an antenna A2ⱼ of the destination communicating entity EC2 for transmission from the communicating entity EC1 to the communicating entity EC2. Thus M1×M2 second propagation channels C2(A1ᵢ→A2ⱼ), for i varying from 1 to M1 and j varying from 1 to M2, are defined between the communicating entities EC1 and EC2.

FIG. 1 shows only those means of the source and destination communicating entities that relate to the invention.

The source and destination communicating entities further include a central control unit, not shown, connected to the means that they include to control the operation thereof.

The source communicating entity further includes a generator of data signals including M1 antenna signals. Such antenna signals are defined by binary data through methods of modulation, coding and distribution to the M1 antennas, for example as described in the paper “Space Block Coding: a simple transmitter diversity technique for wireless communications” by S. Alamouti, published in IEEE Journal Selected Areas In Communications, vol. 16, pp. 1456-1458, October 1998.

The source communicating entity includes:
a selective receiver SEL1 adapted to receive a pulse transmitted by the communicating entity EC2 via all the source antennas and to select a reference antenna on the basis of the impulse responses received;
a transmitter EMET1 adapted to transmit an impulse response delivered by the selected receiver SEL1 via a source antenna A1ᵢ, for i between 1 and M1 inclusive; transmission is effected after transposition of the impulse response to a carrier frequency f1 of the frequency band dedicated to transmission from the communicating entity EC1 to the communicating entity EC2;
a receiver REC1 adapted to receive via the reference antenna a time-reversed combined impulse response transmitted by the destination communicating entity;
a memory MEM1 adapted to store time-reversed combined impulse responses delivered by the receiver REC1;
a pre-equalizer PEGA1 adapted to determine pre-equalization coefficients from a combination of time-reversed combined impulse responses or transfer functions stored in the memory MEM1.

The destination communicating entity includes:
a pulse generator GI2 adapted to transmit a pulse from a destination antenna A2ⱼ, for j between 1 and M2 inclusive, on a carrier frequency f2 from the frequency band dedicated to transmission from the communicating entity EC2 to the communicating entity EC1;
a receiver REC2 adapted to receive via a destination antenna a combined impulse response transmitted by the source communicating entity;
a pulse analyzer RTEMP2 adapted to time reverse a combined impulse response delivered by the receiver REC2;
a transmitter EMET2 adapted to transmit a time-reversed combined impulse response delivered by the pulse analyzer from a destination antenna after transposition to the carrier frequency f2.

The various means of the source and destination communicating entities can be implemented in analog or digital technologies well known to persons skilled in the art.

The method of the invention shown in FIG. 2 for pre-equalizing a data signal comprises steps E1 to E9, some executed in the source communicating entity EC1 and the others in the destination communicating entity EC2. In this example the outcomes of these steps are described in the frequency domain but can be transposed directly to the time domain given the following definitions.

A time pulse is defined by a function imp(t) as a function of time t, of transfer function that is given by IMP(f), which is a function of frequency f. Similarly, an impulse response is defined by a function ri(t) as a function of time t, of transfer function that is given by RI(f), which is a function of frequency f. The convolution product of the impulse responses corresponds to the product of the corresponding transfer functions. A time-reversed impulse response ri(t) is denoted ri(−t) and the corresponding transfer function is RI(f)*, which is conjugate with the transfer function RI(f).

The steps E1 to E8 are repeated for at least some of the destination antennas. The iterations are symbolized by an initialization step INIT and a step IT₁ of incrementing the index j of the destination antennas A2ⱼ. One iteration of the steps E1 to E8 is described for a destination antenna A2ⱼ, for j between 1 and M2 inclusive

In the step E1, the pulse generator GI2 of the destination communicating entity generates the time pulse imp1(t) of transfer function that is IMP1(f). This pulse is transmitted via the antenna A2ⱼ on a carrier frequency f2 in the frequency band dedicated to transmission from the communicating entity EC2 to the communicating entity EC1.

For example, the pulse is a raised cosine function with a duration inversely proportional to the size of the frequency band in which the system functions for any type of access, for example orthogonal frequency division modulation access (OFDMA), code division multiple access (CDMA) or time division multiple access (TDMA).

In the next step E2, the selective receiver SEL1 of the source communicating entity receives the pulse transmitted by the communicating entity EC2 via all the source antennas. The selective receiver determines a reference antenna on the basis of all the pulses received from all the source antennas by comparing the energies received at the various source antennas, for example, and selecting the impulse response with the maximum energy. Alternatively, the selective receiver selects the antenna for which the impulse response received is the least spread in time. Another alternative is for the selective receiver to choose an antenna at random. The selective receiver delivers the impulse response received via the reference antenna to the transmitter EMET1 of the source communicating entity. H1_{ref←j}(f) is the transfer function of the pulse imp(t) that has passed through the first propagation channel C1(ref←j) between the destination antenna A2ⱼ and the reference antenna A1_{ref}.

The steps E3 to E8 are then repeated for at least some of the source antennas. These iterations are symbolized by the initialization step INIT and a step IT2 of incrementing the index i of the source antennas A1ᵢ. The steps E3 to E8 are thus repeated for a source antenna A1ᵢ, for i between 1 and M1 inclusive.

In the step E3, the transmitter EMET1 transposes the pulse delivered by the selective receiver from the frequency f2 to a carrier frequency f1 from the frequency band dedicated to transmission from the communicating entity EC1 to the communicating entity EC2.

The received pulse transposed to the carrier frequency f1 is then transmitted via the antenna A1ᵢ to the destination communicating entity.

In the step E4, the receiver REC2 of the destination communicating entity receives a combined impulse response ri_{comb}(t) via all the destination antennas. The receiver REC2 selects the combined impulse response received via the antenna A2ⱼ corresponding to a round trip of the pulse transmitted during the step E1. The transfer function ri_{comb}(t) representing successive passage through the first and second propagation channels is given by the equation:

RI_{comb}(f)=H2ᵢ_{_{→}}ⱼ(f)×H1_{ref}_{_{←}}ⱼ(f)

where H1_{ref←j}(f) is the transfer function of the first propagation channel C1(A1_{ref}←A2ⱼ) and H2_{i→j}(f) is the transfer function of the second propagation channel C2(A1ᵢ→A2ⱼ). The receiver REC2 delivers the combined impulse response to the pulse analyzer RTEMP2 of the destination communicating entity.

In the step E5, the pulse analyzer RTEMP2 time reverses the combined impulse response. To this end, the pulse analyzer stores the combined impulse response and the coefficients of the combined impulse response, for example, and classifies their conjugates in the reverse order to the coefficients of ri_{comb}(t). The transfer function of the time-reversed combined impulse response ri_{comb}(−t) is therefore given by the equation:

RI_{comb}(f)*=[H2ᵢ_{_{→}}ⱼ(f)]*×[H1_{ref}_{_{←}}ⱼ(f)]*

Alternatively, the pulse analyzer analyzes the impulse response ri_{comb}(t) using an analog splitter and deduces from it a discrete model of the combined impulse response. The analyzer then carries out time reversal using the discrete model.

The pulse analyzer then delivers the impulse response ri_{comb}(−t) to the transmitter EMET2 of the destination communicating entity.

In the step E6, following transposition to the carrier frequency f2, the transmitter EMET2 transmits the time-reversed combined impulse response via the antenna A2ⱼ to the source communicating entity.

In the step E7, the source communicating entity receives the time-reversed combined impulse response transmitted by the destination communicating entity via all the source antennas. The receiver REC1 of the source communicating entity selects the time-reversed combined impulse response received via the reference antenna Al_{ref}.

The transfer function Hᵢⱼ(f) of the impulse response ri_{comb}(−t) after passing through the first propagation channel C1(ref 4-j) is given by the equation:

Hᵢⱼ(f)=H1_{ref}_{_{←}}ⱼ(f)×[H2ᵢ_{_{→}}ⱼ(f)]*×[H1_{ref}_{_{←}}ⱼ(f)]*

The receiver REC1 then delivers to the memory MEM1 of the source communicating entity the coefficients of the transfer function Hᵢⱼ(f) or the corresponding impulse response riᵢⱼ(t).

The steps E1 to E8 being repeated for some of the destination antennas and the steps E3 to E8 being repeated for some of the source antennas, the memory MEM1 of the source communicating entity includes a set of stored transfer functions or impulse responses. For iterations effected on M1 destination antennas and M2 source antennas, the memory MEM1 contains the transfer functions Hᵢⱼ(f) for i varying from 1 to M1 and j varying from 1 to M2.

In step E9, the pre-equalizer PEGA1 of the source communicating entity determines pre-equalization coefficients of a data signal S(t) including M1 antenna signals S₁(t), . . . , Sᵢ(t), . . . , S_{M1} (t) by combining transfer functions Hᵢⱼ(f) to form a set FI of M1 pre-equalization filters FIᵢ(f), i varying from 1 to M1. The antenna signal Sᵢ(t) transmitted via the antenna A1ᵢ is therefore shaped by applying the corresponding filter FIᵢ(f) defined by the following equation:

$${FI}_{i} ( f ) = {\sum }_{j = 1}^{M 2} {C}_{j} {H}_{ij} ( f )$$

The weighting coefficients Cⱼ, for j between 1 and M2 inclusive, are configurable parameters determined as a function of the method used to generate a data signal. These parameters are also updated, for example when turning a destination antenna off or on, as a function of the evolution over time of the states of the propagation channels.

After the step E9, the data signal is pre-equalized by filtering each of the antenna signals by the corresponding filter of the set FI and sent by the communicating entity EC1 to the communicating entity EC2.

In one particular implementation, steps E3 to E8 are executed for only one source antenna A1ᵢ from the set of source antennas. This implementation corresponds to the situation in which the data signal to be equalized is the antenna signal Sᵢ(t). The memory MEM1 of the source communicating entity contains M2 transfer functions Hᵢⱼ(f) for j varying from 1 to M2. The pre-equalizer PEGA1 determines a single pre-equalization filter FIᵢ(f). The antenna signal Sᵢ(t) transmitted via the antenna A1ᵢ is therefore shaped by applying the corresponding filter FIᵢ(f) given by the equation:

$${FI}_{i} ( f ) = {\sum }_{j = 1}^{M 2} {C}_{j} {H}_{ij} ( f )$$

In one particular embodiment, the set of source antennas contains only one source antenna A2₁. Steps E1 to E8 are executed in succession only to transmit a single pulse via the antenna A2₁ of the destination communicating entity. Steps E3 to E8 are repeated for at least one portion of the source communicating entity.

In an illustrative example in which the steps E3 to E8 are repeated for all the source antennas, in the step E9 the pre-equalizer determines pre-equalization coefficients as a function of M1 transfer functions Hᵢₗ₋(f), for i varying from 1 to M1. The set FI of M1 pre-equalization filters FIᵢ(f) to be applied to the data signals is given by the equation:

FI=[FI₁, . . . , FIᵢ(f), . . . . FI_{M1}(f)] where FIᵢ(f)=Hᵢ₁(f)

In one particular embodiment, the set of source antennas contains only one source antenna A1₁. The data signal then includes only one antenna signal S₁(t) transmitted by the only antenna A1₁ and the reference antenna is the source antenna A1₁. The steps E3 to E8 are then effected only for this single antenna A1₁ of the source communicating entity.

By way of illustrative example, when steps E1 to E8 are repeated for all the destination antennas, in step E9 M2 transfer functions H₁ⱼ, for j varying from 1 to M2, are available. The pre-equalizer determines a single pre-equalization filter FI₁(f) applied to the data signal on the basis of M2 coefficients Cⱼ such that:

$${FI}_{1} ( f ) = {\sum }_{j = 1}^{M 2} {C}_{j} {H}_{1 j} ( f )$$

In one particular embodiment, the set of source antennas contains only one source antenna A1₁ and the set of destination antennas contains only one destination antenna A2₁. The data signal includes only one antenna signal S₁(t) transmitted via the single antenna A1₁ and the reference antenna of the source entity is the antenna A1₁. In step E9, the transfer function H₁₁ determines a single pre-equalization filter FI₁(f) given by the equation:

FI₁(f)=H₁₁(f)

In one particular embodiment, the source communicating entity having M1 source antennas and the destination communicating entity having M2 destination antennas, the step E9 of determining the pre-equalization coefficients of the data signal including M1 antenna signals is carried out after iteration of steps E1 to E8 with no intermediate iteration of steps E3 to E8. An iteration of steps E1 to E9 is then effected for all source antenna/destination antenna pairs (A1ᵢ, A2ⱼ) for i varying from 1 to M1 and j varying from 1 to M2.

In the implementations of the invention described, the iteration loops are effected for some of the destination antennas and some of the source antennas. The number and choice of antennas are configurable parameters of the method. They are determined as a function of the characteristics of the antennas, for example.

The method can also be used for bidirectional transmission. In this particular implementation, the method is used in the uplink direction and the downlink direction so that a pulse and an antenna signal are not transmitted simultaneously by a communicating entity. This is in order to ensure the processing of impulse responses representing passing through one or more propagation channels.

The invention described here provides a device used in a source communicating entity to pre-equalize a data signal. Consequently, the invention also provides a computer program, notably a computer program on or in an information storage medium, adapted to implement the invention. This program can use any programming language and take the form of source code, object code or a code intermediate between source code and object code, such as a partially-compiled form, or any other form suitable for implementing those of the steps of the method of the invention executed in the source communication entity.

The invention described here also provides a device used in a destination communicating entity to pre-equalize a data signal. Consequently, the invention also provides a computer program, notably a computer program on or in an information storage medium, adapted to implement the invention. This program can use any programming language and take the form of source code, object code or a code intermediate between source code and object code, such as a partially-compiled form, or any other form suitable for implementing those of the steps of the method of the invention executed in the destination communication entity.

1. A method of pre-equalizing a frequency-division duplex data signal transmitted by a source communicating entity having a set of source antennas to a destination communicating entity having a set of destination antennas, said method comprising steps of:
transmitting a pulse via a destination antenna to the source communicating entity;
iterative processing of said pulse comprising:
a substep of a source antenna transmitting to the destination communicating entity said pulse received by a reference antenna of the set of source antennas;
a substep of the destination communicating entity time reversing the combined impulse response representing the successive passage of said pulse through a first propagation channel between the destination antenna and the reference antenna and a second propagation channel between the source antenna and the destination antenna; and
a substep of the destination antenna transmitting said time-reversed combined impulse response to the source communicating entity;
said step of iterative processing of said pulse being repeated for at least some of the source antennas;
said steps of transmission of a pulse by a destination antenna and iterative processing of said pulse being repeated for at least some of the destination antennas; and of determining pre-equalization coefficients of the data signal from a combination of a set of time-reversed combined impulse responses received by the source communicating entity.

2. The method according to claim 1, wherein the substep of transmitting the received pulse includes beforehand a step of selecting the reference antenna as a function of a set of pulses received by the set of source antennas.

3. The method according to claim 2, wherein the reference antenna is selected as a function of the energy of all the pulses received by the set of source antennas.

4. The method according to claim 1, wherein the data signal pre-equalization coefficients are determined from a combination of a set of time-reversed combined impulse responses received by the reference antenna of the source communicating entity.

5. A device for pre-equalizing a data signal for a source communicating entity having a set of source antennas, said source communicating entity being adapted to transmit said signal, using frequency-division duplexing, to a destination communicating entity having a set of destination antennas, said device comprising means for:
receiving a pulse transmitted by a destination antenna;
transmitting the received pulse to the destination communicating entity via a source antenna;
receiving a time-reversed combined impulse response representing successive passage of said transmitted pulse through a first propagation channel between the destination antenna and a reference antenna of the set of source antennas and a second propagation channel between the source antenna and the destination antenna;
determining coefficients for pre-equalizing the data signal on the basis of a combination of a set of received time-reversed combined impulse responses;
the transmission and reception means being used iteratively for at least some of the destination antennas and at least some of the source antennas.

6. A device for pre-equalizing a data signal for a destination communicating entity, comprising a set of destination antennas, said destination communicating entity being adapted to receive said data signal transmitted, using frequency-division duplexing, by a source communicating entity comprising a set of source antennas, said device further comprising means for:
transmission of a pulse to the source communicating entity by a destination antenna;
receiving a combined impulse response representing successive passage of said pulse through a first propagation channel between the destination antenna and a reference antenna of the set of source antennas and a second propagation channel between a source antenna and the destination antenna;
time reversing the combined impulse response;
transmitting said time-reversed combined impulse response;
the transmission, reception and time reversing means being employed iteratively for at least some of the destination antennas and at least some of the source antennas.

7. A communicating entity of a radio communications system, comprising at least one device according to claim 5.

8. A radio communications system comprising at least two communicating entities according to claim 7.

9. A non-transitory computer program product, comprising a computer usable medium having a computer readable program code embodied therein, said computer readable program code adapted to be executed to implement a method for a source communicating entity, including software instructions for controlling the execution by said entity of those of the steps of the method according to claim 1 that are executed by the source communicating entity when the program is executed by the source communicating entity.

10. A non-transitory computer program product, comprising a computer usable medium having a computer readable program code embodied therein, said computer readable program code adapted to be executed to implement a method for a destination communicating entity, including software instructions for controlling the execution by said entity of those of the steps of the method according to claim 1 that are executed by the destination communicating entity when the program is executed by the destination communicating entity.
